(19) United States
(12) Patent Application Publication
(10) Pub. No.: US 2017/0265685 A1
(43) Pub. Date: Sep. 21, 2017

(54) PANCAKE MOLD

(71) Applicants: AMANDA E. DANIELS, CANTON, MI (US); CHARLES P. DANIELS, CANTON, MI (US)

(72) Inventors: AMANDA E. DANIELS, CANTON, MI (US); CHARLES P. DANIELS, CANTON, MI (US)

(21) Appl. No.: 15/463,620

(22) Filed: Mar. 20, 2017

Related U.S. Application Data
(60) Provisional application No. 62/310,037, filed on Mar. 18, 2016.

(51) Int. Cl. A47J 43/20; A23L 5/10

(52) U.S. Cl. CPC A47J 43/20; A23L 5/10; A23V 2002/00

(57) ABSTRACT

A flexible polymer cooking utensil includes a body of the cooking utensil and at least one tab extending outwardly from a perimeter of the body of the cooking utensil. The body of the cooking utensil includes a first flat face surface, a second flat face surface, and a batter cavity formed in the second flat face surface comprising a decorative pattern formed in the batter cavity.

### CROSS REFERENCE TO RELATED APPLICATIONS

This disclosure claims the benefit of U.S. Provisional Application No. 62/310,037 filed on Mar. 18, 2016 which is hereby incorporated by reference.

### TECHNICAL FIELD

This disclosure is related to a flexible cooking utensil, particularly to a polymer cooking mold useful for creating a design upon a baked product such as breakfast pancake, brownie, or similar dessert item.

### BACKGROUND

The statements in this section merely provide background information related to the present disclosure. Accordingly, such statements are not intended to constitute an admission of prior art.

Cooking molds are known in the art. Breakfast waffles are created by pouring batter into a double-sided heated cooking mold. Bundt cakes are created by pouring batter into a rigid metal Bundt-style cake pan.

Pancakes are traditionally poured into a griddle or pan and flipped once to cook them. They can also be poured into mechanical devices such as waffle makers or cookie cutter like molds to make them into a particular shape.

### SUMMARY

A flexible polymer cooking utensil includes a body of the cooking utensil and at least one tab extending outwardly from a perimeter of the body of the cooking utensil. The body of the cooking utensil includes a first flat face surface, a second flat face surface, and a batter cavity formed in the second flat face surface comprising a decorative pattern formed in the batter cavity.

### BRIEF DESCRIPTION OF THE DRAWINGS

One or more embodiments will now be described, by way of example, with reference to the accompanying drawings, in which:

FIG. 1 illustrates a flat bottom surface of an exemplary flexible polymer cooking utensil including tabs extending from a perimeter of a body of the utensil, in accordance with the present disclosure.

FIG. 2 illustrates one exemplary embodiment of the flexible polymer cooking utensil of FIG. 1 in side view, with two tabs extending from a perimeter of a first flat face surface of the body of the utensil, in accordance with the present disclosure. The tabs extend outwardly in a same plane as the neighboring flat face surface.

FIG. 3 illustrates another exemplary embodiment of the flexible polymer cooking utensil of FIG. 1 in side view, with two tabs extending from a perimeter of a first flat face surface of the body of the utensil and with two additional tabs extending from a perimeter of a second flat face surface of the body of the utensil, in accordance with the present disclosure. The tabs extend outwardly in a same plane as the neighboring flat face surfaces.

FIG. 4 illustrates a top flat face surface of the flexible polymer cooking utensil of FIG. 1, including a decorative batter cavity, in accordance with the present disclosure.

FIG. 5 illustrates a flow chart describing an exemplary process for using a flexible polymer cooking utensil to create a food product, in accordance with the present disclosure.

FIG. 6 illustrates an exemplary alternative embodiment of a flexible polymer cooking utensil, including tabs extending at an angle away from an adjacent flat face surface of the cooking utensil, in accordance with the present disclosure.

FIG. 7 illustrates an exemplary alternative embodiment of a flexible polymer cooking utensil in side view cross-section, the utensil including two halves, each including a decorative batter cavity, the two halves joined at one side, in accordance with the present disclosure.

FIG. 8 illustrates an exemplary alternative embodiment of a flexible polymer cooking utensil including an alternative rectangular perimeter with four tabs extending from the corners of the rectangular shape, in accordance with the present disclosure.

FIG. 9 illustrates an exemplary alternative embodiment of a flexible polymer cooking utensil in side view cross section, the utensil including a plurality of filling product suspension posts, in accordance with the present disclosure.

FIG. 10 illustrates a flow chart describing an alternative exemplary process for using a flexible polymer cooking utensil to create a food product, in accordance with the present disclosure.

FIG. 11 illustrates through a photograph an exemplary pancake created with the cooking utensil of FIG. 4 and the process of FIG. 5 resting upon a white plate, in accordance with the present disclosure.

### DETAILED DESCRIPTION

A flexible polymer cooking utensil including a batter cavity and a decorative pattern is disclosed, enabling one to pour batter into batter cavity and transfer a decorative design onto a finished food product from the decorative pattern of the utensil. The utensil includes at least one tab extending from a perimeter of the mold making it easy for a user to flip or remove the mold from the cooking surface.

The flexible polymer material includes a food grade product that is safe for cooking food products in an exemplary stove-top griddle environment and can include examples of food grade silicone. The utensil includes a first flat cooking surface side, configured to be set down upon a cooking surface of the griddle while the batter is poured into the cavity. The utensil additionally includes a second cooking surface side into which the cavity is formed. The flexible polymer material enables the batter poured inside the utensil to be cooked from either side, with the first flat cooking surface side laying upon a griddle surface or with the second cooking surface side laying upon the griddle surface. In this way, one side (e.g. brownie or lemon bar) or both sides (e.g. pancake) can be placed upon a cooking surface.

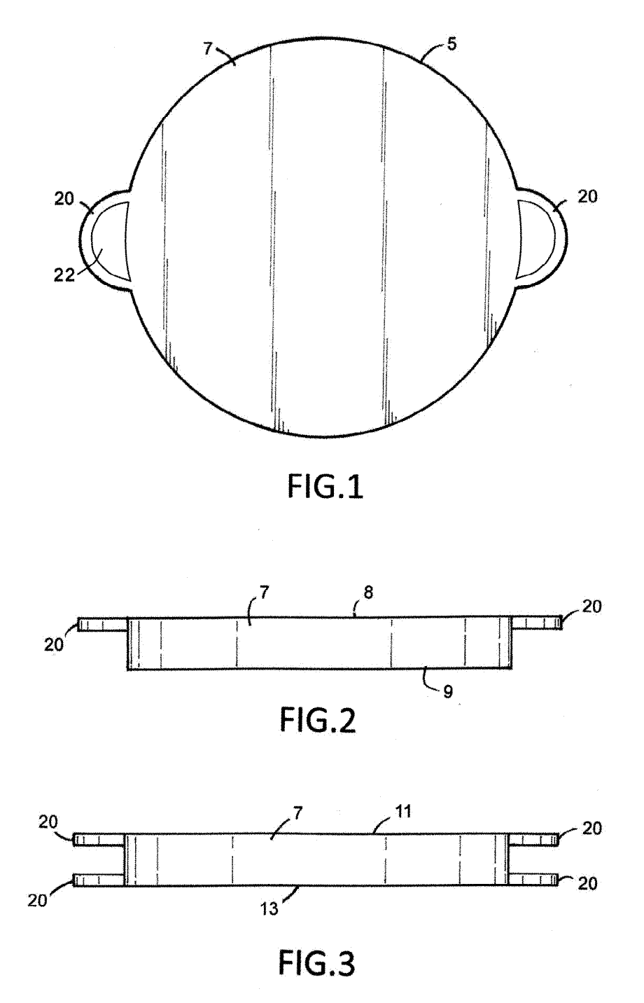

Referring now to the drawings, wherein the showings are for the purpose of illustrating certain exemplary embodiments only and not for the purpose of limiting the same, FIG. 1 illustrates a flat bottom surface of an exemplary flexible polymer cooking utensil including tabs extending from a perimeter of a body of the utensil. Cooking utensil 5 is illustrated, including round body 7 with two tabs 20 extending outwardly from a perimeter of body 7. Tab 20 includes an optional cutout feature 22 configured to provide a through hole for an exemplary fork to lift the utensil.

FIG. 2 illustrates one exemplary embodiment of the flexible polymer cooking utensil of FIG. 1 in side view, with two tabs extending from a perimeter of a first flat face surface of the body of the utensil. Body 7 of the utensil includes a first flat face surface 8 and a second flat face surface 9. Tabs 20 are illustrated flush with first flat face surface 8.

FIG. 3 illustrates an alternative exemplary embodiment of the flexible polymer cooking utensil of FIG. 1 in side view, with two tabs extending from a perimeter of a first flat face surface of the body of the utensil and with two additional tabs extending from a perimeter of a second flat face surface of the body of the utensil. Body 7 of the utensil includes a first flat face surface 8 and a second flat face surface 9. Tabs 20 are illustrated flush with first flat face surface 8 and flush with second flat face surface 9.

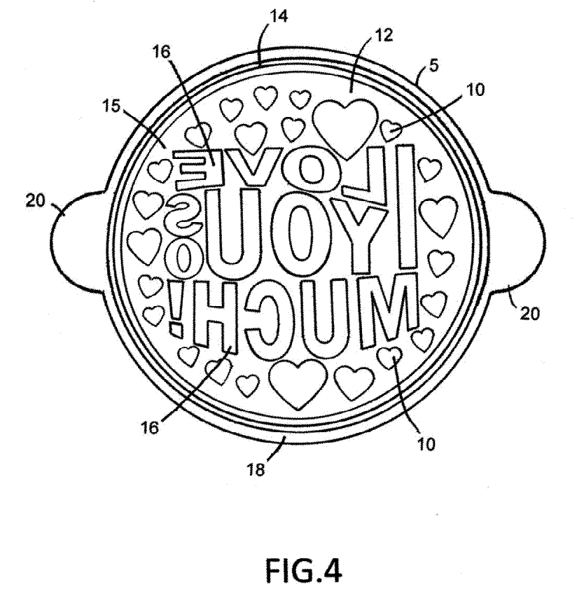

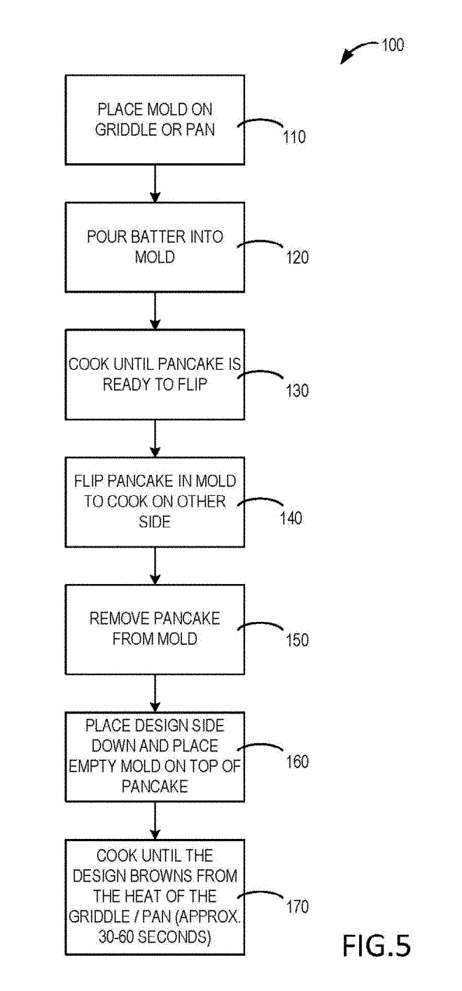

FIG. 4 illustrates a top flat face surface of the flexible polymer cooking utensil of FIG. 1, including a decorative batter cavity. Cooking utensil 5 is illustrated from a top surface including batter cavity 15. Batter cavity 15 includes a flat bottom plain 12 and raised design elements 10. Batter can be poured into batter cavity 15, and as cooking utensil 5 is placed upon a cooking surface, heat is transferred through the polymer material to cook the batter. Flat face surface 18 is provided and can be used as a fill mark for batter. Raised elements 10 can include many different decorative patterns. The exemplary decorative pattern of FIG. 4 includes raised text 16, which is illustrated in mirror image of the desired final text to be created upon the food product. Tabs 20 are illustrated enabling one to grip cooking utensil 5 and either flip or lift the cooking utensil at a desired point in the cooking process.

FIG. 5 illustrates a flow chart describing an exemplary process for using a flexible polymer cooking utensil to create a food product. Process 100 includes cooking a breakfast pancake and starts at step 110 where a user places the cooking utensil or mold upon a cooking surface of a griddle or pan. Step 120 includes pouring batter into the cavity of the cooking utensil. Step 130 includes cooking the pancake batter until the pancake is ready to be flipped. Step 140 includes flipping the cooking utensil and included food product unitarily, with the cavity including the cooking batter facing down toward the cooking surface. Step 150 includes removing the cooking utensil or mold from the pancake, with only the pancake remaining upon the cooking surface. Step 160 includes flipping the pancake, such that a decorated face created within the batter cavity of the cooking utensil is upon the cooking surface. Step 170 includes placing the flat bottom side or undecorated side of the cooking utensil upon the flat, undecorated side of the pancake. Step 180 includes removing the finished pancake from the cooking surface.

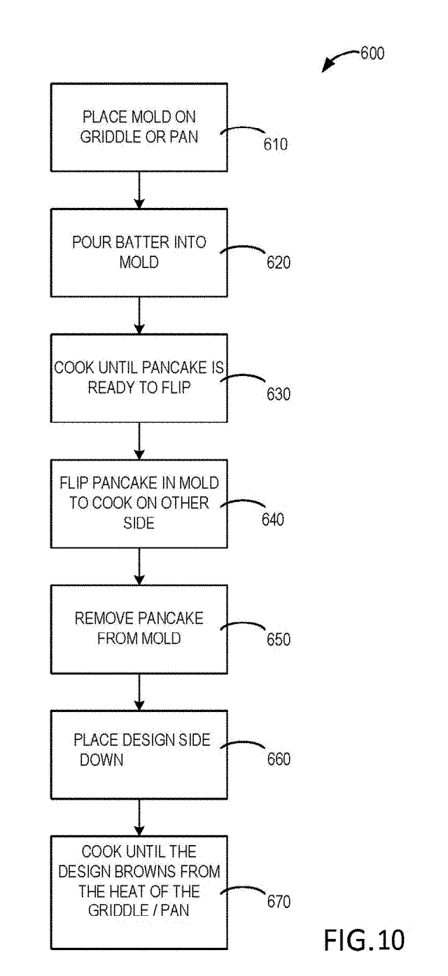

FIG. 10 illustrates a flow chart describing an alternative exemplary process for using a flexible polymer cooking utensil to create a food product. Process 600 differs from process 100 slightly, eliminating a portion where the mold is place upon the pancake and making optional browning the decorative portion of the pancake. Process 600 includes cooking a breakfast pancake and starts at step 610 where a user places the cooking utensil or mold upon a cooking surface of a griddle or pan. Step 620 includes pouring batter into the cavity of the cooking utensil. Step 630 includes cooking the pancake batter until the pancake is ready to be flipped. Step 640 includes flipping the cooking utensil and included food product unitarily, with the cavity including the cooking batter facing down toward the cooking surface. Step 650 includes removing the cooking utensil or mold from the pancake, with only the pancake remaining upon the cooking surface. Optional step 660 includes flipping the pancake, such that a decorated face created within the batter cavity of the cooking utensil is upon the cooking surface. Optional step 670 includes cooking the pancake until the design portion of the pancake browns slightly.

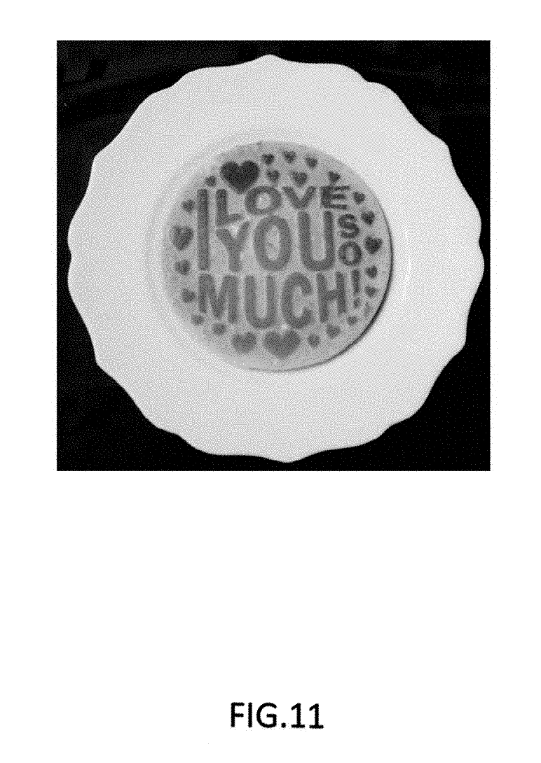

FIG. 11 illustrates through a photograph an exemplary pancake created with the cooking utensil of FIG. 4 and the process of FIG. 5.

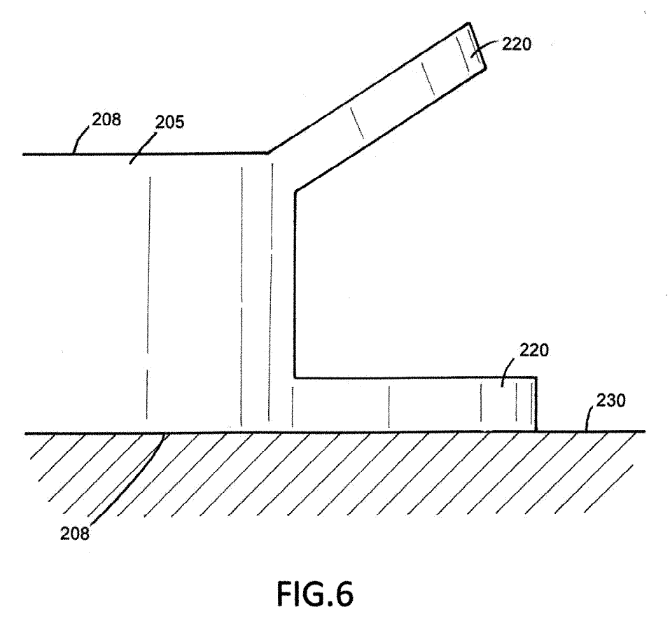

FIG. 6 illustrates an exemplary alternative embodiment of a flexible polymer cooking utensil, including tabs extending at an angle away from an adjacent flat face surface of the cooking utensil. Cooking utensil 205 is illustrated placed upon cooking surface 230. Cooking utensil 205 includes two tabs 220, each formed upon a perimeter of cooking utensil 205. Tabs 220 are formed extending at an angle away from neighboring flat face surfaces 208 of cooking utensil 205. Laying utensil 205 upon cooking surface 230 bends the lower of tabs 220, such that the lower tab extends flat with the neighboring flat face surface 208. In this way, the top tab 220 extends upwardly, enabling a user to easily grip upon that tab extending upwardly from the cooking surface, while the lower tab 220 easily bends flat and does not interfere with the lower flat face surface 208 from lying flat upon cooking surface 230.

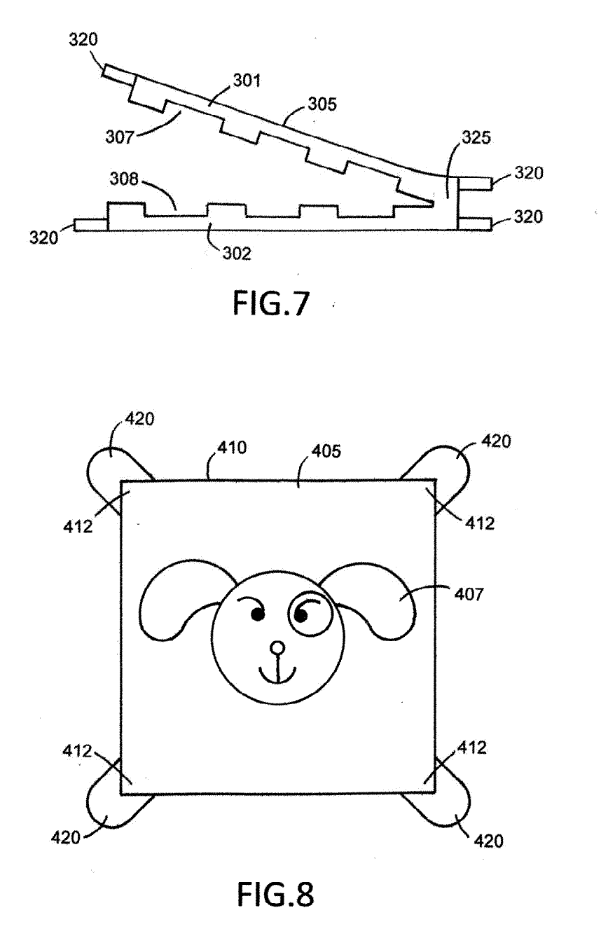

FIG. 7 illustrates an exemplary alternative embodiment of a flexible polymer cooking utensil in side view cross-section, the utensil including two halves, each including a decorative batter cavity, the two halves joined at one side. Cooking utensil 305 is illustrated, including a first half 301 and a second half 302, the two halves joined at portion 325. Half 301 includes batter cavity 307 including decorative features, and half 302 includes batter cavity 308 including additional decorative features. Tabs 320 extend outwardly from perimeters of both halves, 301 and 302, respectively. Batter poured between halves 301 and 302 can be cooked, and decorative designs can be formed on both sides of the resulting food product by the decorative features of cavities 307 and 308, respectively.

Flexible polymer cooking utensils can be made in different shapes and sizes. FIG. 8 illustrates an exemplary alternative embodiment of a flexible polymer cooking utensil including an alternative rectangular perimeter with four tabs extending from the corners of the rectangular shape. Cooking utensil 405 is illustrated including a rectangular perimeter shape 410. Rectangular perimeter shape 410 includes four corners 412, each corner 412 including a tab 420 extending outwardly therefrom. A batter cavity 407 is illustrated formed upon a flat face surface of the cooking utensil 405. The rectangular shape of cooking utensil 405 is exemplary, and the cooking utensil can be constructed with many different perimeter shapes and decorative patterns in the batter cavity.

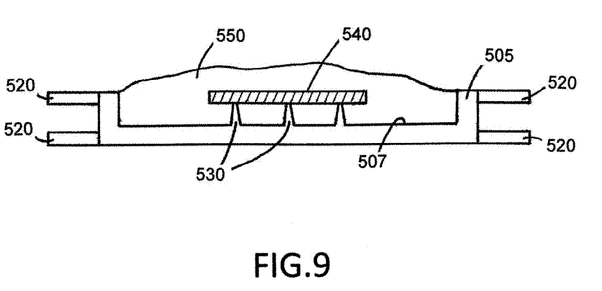

FIG. 9 illustrates an exemplary alternative embodiment of a flexible polymer cooking utensil in side view cross section, the utensil including a plurality of filling product suspension posts. Cooking utensil 505 is illustrated including batter cavity 507 and tabs 520 extending from a perimeter of cooking utensil 505. Filling product suspension posts 530 are illustrated, enabling a filling product 540 such as chocolate or a fruit product, such as a slide of banana, suspended within batter cavity 507. Batter 550 is poured into cavity 507 and around filling product 540, enabling the resulting food product to include cooked batter 550 with filling product 540 included therewithin.

The figures show a batter cavity that results in a single food product being formed. The cooking utensils described herein can include any number of batter cavities with the same or different designs formed therein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A flexible polymer cooking utensil, comprising:
a body of the cooking utensil, comprising:
a first flat face surface;
a second flat face surface; and
a batter cavity formed in the second flat face surface comprising a decorative pattern formed in the batter cavity;
at least one tab extending outwardly from a perimeter of the body of the cooking utensil.

2. The cooking utensil of claim 1, further comprising a second tab; and wherein the tabs extend from the first flat face surface.

3. The cooking utensil of claim 1, further comprising a second tab; and wherein the tabs extend from the second flat face surface.

4. The cooking utensil of claim 1, wherein the tab comprises a first tab;
further comprising a second tab, a third tab, and a fourth tab;
wherein the first tab and the second tab extend outwardly from the perimeter and are connected to the first flat face surface; and
wherein the third tab and the fourth tab extend outwardly from the perimeter and are connected to the second flat face surface.

5. The cooking utensil of claim 4, wherein the first tab and second tab each extend outwardly in a same plane as the first flat face surface; and
wherein the third tab and fourth tab each extend outwardly in a same plane as the second flat face surface.

6. The cooking utensil of claim 4, wherein the first tab and second tab each extend outwardly angled from the first flat face surface; and
wherein the third tab and fourth tab each extend outwardly angled from the second flat face surface.

7. The cooking utensil of claim 1, wherein the utensil comprises two halves, wherein the batter cavity is formed between the two halves.

8. The cooking utensil of claim 1, wherein the body of the cooking utensil is round.

9. The cooking utensil of claim 1, wherein the body of the cooking utensil is rectangular.

10. The cooking utensil of claim 1, wherein the tab comprises a cutout feature configured to provide a through hole for a fork to lift the utensil.

11. A flexible polymer cooking utensil, comprising:
a round body of the cooking utensil, comprising:
a first flat face surface;
a second flat face surface; and
a batter cavity formed in the second flat face surface comprising a decorative pattern formed in the batter cavity;
a first tab and a second tab extending outwardly from a perimeter of the body of the cooking utensil in a same plane as the first flat face surface; and
a third tab and a fourth tab extending outwardly from the perimeter of the body of the cooking utensil in a same plane as the second flat face surface.

12. A process for cooking a food product with a flexible polymer cooking utensil, comprising:
placing the flexible polymer cooking utensil upon a hot cooking surface, the flexible polymer cooking utensil comprising:
a body of the cooking utensil, comprising:
a first flat face surface;
a second flat face surface; and
a batter cavity formed in the second flat face surface comprising a decorative pattern formed in the batter cavity;
at least one tab extending outwardly from a perimeter of the body of the cooking utensil;
pouring food product into the batter cavity;
cooking the food product for a period;
flipping the cooking utensil and the food produce unitarily; and
removing the food product from the cooking utensil.

13. The process of claim 12, further comprising, after removing the food product from the cooking utensil, cooking the food product for a second period until the food product browns.

14. The process of claim 12, further comprising, after removing the food product from the cooking utensil, placing the first flat surface upon a top side of the food product.
